(19) United States
(12) Patent Application Publication
(10) Pub. No.: US 2012/0202959 A1
(43) Pub. Date: Aug. 9, 2012

(54) Process for Producing Water-Absorbing Polymer Particles

(75) Inventors: Norbert Herfert, Altenstadt (DE); Thomas Daniel, Waldsee (DE); Klaus Dieter Hörner, Lampertheim (DE)

(73) Assignee: BASF SE, Ludwigshafen (DE)

(21) Appl. No.: 13/364,084

(22) Filed: Feb. 1, 2012

Related U.S. Application Data
(60) Provisional application No. 61/439,958, filed on Feb. 7, 2011.

(51) Int. Cl. C08F 220/06; C08F 220/14; C08F 228/02

(52) U.S. Cl. 526/287; 526/318.4; 526/318.5

(57) ABSTRACT

A process for producing water-absorbing polymer particles with improved free swell rate by polymerizing a monomer solution or suspension comprising an ethylenically unsaturated monomer bearing acid groups, an ethylenically unsaturated monomer, a crosslinker and an initiator.

The present invention relates to a process for producing water-absorbing polymer particles with improved free swell rate by polymerizing a monomer solution or suspension comprising an ethylenically unsaturated monomer bearing acid groups, an ethylenically unsaturated monomer, a crosslinker and an initiator.

Water-absorbing polymer particles are used to produce diapers, tampons, sanitary napkins and other hygiene articles, but also as water-retaining agents in market gardening. The water-absorbing polymer particles are also referred to as superabsorbents.

The production of the water-absorbing polymer particles is described in the monograph “Modern Superabsorbent Polymer Technology”, F. L. Buchholz and A. T. Graham, Wiley-VCH, 1998, pages 71 to 103.

The properties of the water-absorbing polymer particles can be adjusted, for example, via the amount of crosslinker used. With an increasing amount of crosslinker, the centrifuge retention capacity (CRC) falls and the absorption under a pressure of 21.0 g/cm² (AUL0.3 psi) passes through a maximum.

To improve the use properties, for example, permeability of the swollen gel bed (SFC) in the diaper and absorption under a pressure of 49.2 g/cm² (AUL0.7 psi), water-absorbing polymer particles are generally surface postcrosslinked. This increases the crosslinking of the particle surface, which can at least partly decouple the absorption under a pressure of 49.2 g/cm² (AUL0.7 psi) and the centrifuge retention capacity (CRC). This surface postcrosslinking can be performed in aqueous gel phase. Preferably, however, dried, ground and sieved polymer particles (base polymer) are surface coated with a surface postcrosslinker and thermally surface postcrosslinked. Crosslinkers suitable for that purpose are compounds which can form covalent bonds to at least two carboxylate groups of the water-absorbing polymer particles.

It was an object of the present invention to provide an improved process for producing water-absorbing polymer particles, especially water-absorbing polymer particles with a high free swell rate (FSR) and high absorption under a pressure of 49.2 g/cm² (AUL0.7 psi).

The object was achieved by a process for producing water-absorbing polymer particles by polymerizing a monomer solution or suspension comprising

a) an ethylenically unsaturated monomer which bears acid groups and may be at least partly neutralized,

b) at least one crosslinker,

c) at least one initiator,

d) at least one ethylenically unsaturated monomer copolymerizable with the monomers mentioned under a) and

e) optionally one or more water-soluble polymers,

wherein the monomer solution or suspension comprises at least 0.5 equivalent by weight of a crosslinker b), where one equivalent by weight corresponds to the percentage by weight of the crosslinker b), based on the unneutralized monomer a), multiplied by (n−1) and n is the number of ethylenic double bonds in the crosslinker b), and from 7.5 to 50% by weight of monomer d), based on the unneutralized monomer a).

The water-absorbing polymer particles are typically water-insoluble.

The monomer a) is preferably water-soluble, i.e. the solubility in water at 23° C. is typically at least 1 g/100 g of water, preferably at least 5 g/100 g of water, more preferably at least 25 g/100 g of water, most preferably at least 35 g/100 g of water.

Suitable monomers a) are, for example, ethylenically unsaturated carboxylic acids, such as acrylic acid, methacrylic acid and itaconic acid. Particularly preferred monomers a) are acrylic acid and methacrylic acid. Very particular preference is given to acrylic acid.

Further suitable monomers a) are, for example, ethylenically unsaturated sulfonic acids, such as styrenesulfonic acid and 2-acrylamido-2-methylpropanesulfonic acid (AMPS).

Impurities can have a considerable influence on the polymerization. The raw materials used should therefore have a maximum purity. It is therefore often advantageous to specially purify the monomers a). Suitable purification processes are described, for example, in WO 2002/055469 A1, WO 2003/078378 A1 and WO 2004/035514 A1. A suitable monomer a) is, for example, acrylic acid purified according to WO 2004/035514 A1 and comprising 99.8460% by weight of acrylic acid, 0.0950% by weight of acetic acid, 0.0332% by weight of water, 0.0203% by weight of propionic acid, 0.0001% by weight of furfurals, 0.0001% by weight of maleic anhydride, 0.0003% by weight of diacrylic acid and 0.0050% by weight of hydroquinone monomethyl ether.

The monomer a) typically comprises polymerization inhibitors, preferably hydroquinone monoethers, as storage stabilizers.

The monomer solution comprises preferably up to 250 ppm by weight, preferably at most 130 ppm by weight, more preferably at most 70 ppm by weight, and preferably at least 10 ppm by weight, more preferably at least 30 ppm by weight and especially around 50 ppm by weight, of hydroquinone monoether, based in each case on the unneutralized monomer a). For example, the monomer solution can be prepared by using an ethylenically unsaturated monomer bearing acid groups with an appropriate content of hydroquinone monoether.

Preferred hydroquinone monoethers are hydroquinone monomethyl ether (MEHQ) and/or alpha-tocopherol (vitamin E).

Suitable crosslinkers b) are compounds having at least two groups suitable for crosslinking. Such groups are, for example, ethylenically unsaturated groups which can be polymerized free-radically into the polymer chain, and functional groups which can form covalent bonds with the acid groups of the monomer a). In addition, polyvalent metal salts which can form coordinate bonds with at least two acid groups of the monomer a) are also suitable as crosslinkers b).

Crosslinkers b) are preferably compounds having at least two polymerizable groups which can be polymerized free-radically into the polymer network. Suitable crosslinkers b) are, for example, ethylene glycol dimethacrylate, diethylene glycol diacrylate, polyethylene glycol diacrylate, allyl methacrylate, trimethylolpropane triacrylate, triallylamine, tetraallylammonium chloride, tetraallyloxyethane, as described in EP 0 530 438 A1, di- and triacrylates, as described in EP 0 547 847 A1, EP 0 559 476 A1, EP 0 632 068 A1, WO 93/21237 A1, WO 2003/104299 A1, WO 2003/104300 A1, WO 2003/104301 A1 and DE 103 31 450 A1, mixed acrylates which, as well as acrylate groups, comprise further ethylenically unsaturated groups, as described in DE 103 31 456 A1 and DE 103 55 401 A1, or crosslinker mixtures, as described, for example, in DE 195 43 368 A1, DE 196 46 484 A1, WO 90/15830 A1 and WO 2002/032962 A2.

Preferred crosslinkers b) are pentaerythrityl triallyl ether, tetraallyloxyethane, methylenebismethacrylamide, 15-tuply ethoxylated trimethylolpropane triacrylate, polyethylene glycol diacrylate, trimethylolpropane triacrylate, triallylamine and tetraallylammonium chloride.

Very particularly preferred crosslinkers b) are the polyethoxylated and/or -propoxylated glycerols which have been esterified with acrylic acid or methacrylic acid to give di- or triacrylates, as described, for example, in WO 2003/104301 A1. Di- and/or triacrylates of 3- to 10-tuply ethoxylated glycerol are particularly advantageous. Very particular preference is given to di- or triacrylates of 1- to 5-tuply ethoxylated and/or propoxylated glycerol. Most preferred are the triacrylates of 3- to 5-tuply ethoxylated and/or propoxylated glycerol, especially the triacrylate of 3-tuply ethoxylated glycerol.

The amount of crosslinker b) is preferably 0.6 to 2 equivalents by weight, more preferably 0.65 to 1.5 equivalents by weight and most preferably 0.7 to 1 equivalent by weight, based in each case on the unneutralized monomer a). With rising crosslinker content, the centrifuge retention capacity (CRC) falls and the absorption under a pressure of 21.0 g/cm² passes through a maximum.

One equivalent by weight corresponds to the percentage by weight of the crosslinker b), based on the unneutralized monomer a), multiplied by (n−1), where and n is the number of ethylenic double bonds in the crosslinker b). For crosslinkers b) with two ethylenic double bonds, such as methylenebisacrylamide or polyethylene glycol diacrylate, one percent by weight also corresponds to one equivalent by weight, and for crosslinkers b) with three ethylenic double bonds, such as 15-tuply ethoxylated trimethylolpropane triacrylate or triallylamine, one percent by weight accordingly corresponds to two equivalents by weight.

The initiators c) used may be all compounds which generate free radicals under the polymerization conditions, for example thermal initiators, redox initiators, photoinitiators. Suitable redox initiators are sodium peroxodisulfate/ascorbic acid, hydrogen peroxide/ascorbic acid, sodium peroxodisulfate/sodium bisulfite and hydrogen peroxide/sodium bisulfite. Preference is given to using mixtures of thermal initiators and redox initiators, such as sodium peroxodisulfate/hydrogen peroxide/ascorbic acid. However, the reducing component used is preferably a mixture of the disodium salt of 2-hydroxy-2-sulfinatoacetic acid, the disodium salt of 2-hydroxy-2-sulfonatoacetic acid and sodium bisulfite (obtainable as Brüggolit® FF6 and Bruggolit® FF7 from Brüggemann Chemicals; Heilbronn; Germany) or the disodium salt of 2-hydroxy-2-sulfinatoacetic acid in pure form (obtainable as Blancolen® HP from Brüggemann Chemicals; Heilbronn; Germany).

The ethylenically unsaturated monomers d) copolymerizable with the ethylenically unsaturated monomers a) which bear acid groups are not subject to any restriction. It is possible that the monomers d) are themselves ethylenically unsaturated monomers bearing acid groups and/or salts thereof. What is important here is merely that the monomers d) are different than the monomer a).

Suitable monomers d) are, for example, ethylenically unsaturated carboxylic acids, such as acrylic acid, methacrylic acid and itaconic acid, and also ethylenically unsaturated sulfonic acids, such as styrenesulfonic acid and 2-acrylamido-2-methylpropanesulfonic acid (AMPS). Particularly preferred monomers d) are methacrylic acid, itaconic acid and 2-acrylamido-2-methylpropanesulfonic acid. Very particular preference is given to methacrylic acid and 2-acrylamido-2-methylpropanesulfonic acid.

Further suitable monomers d) are, for example, acrylamide, methacrylamide, tert-butylacrylamide, hydroxyethyl acrylate, hydroxyethyl methacrylate, methyl methacrylate, methyl acrylate, ethyl methacrylate, ethyl acrylate, n-propyl methacrylate, n-propyl acrylate, n-butyl methacrylate, n-butyl acrylate, tert-butyl methacrylate, tert-butyl acrylate, cyclohexyl methacrylate, cyclohexyl acrylate, dimethylaminoethyl methacrylate, dimethylaminoethyl acrylate, dimethylaminopropyl acrylate, diethylaminoethyl methacrylate, diethylaminopropyl acrylate, dimethylaminoethyl-methacrylamide, dimethylaminoethylacrylamide, dimethylaminopropylacrylamide, diethylaminoethylmethacrylamide, diethylaminopropylacrylamide, methylglycol methacrylate, methylglycol acrylate, ethylglycol methacrylate, ethylglycol acrylate, n-propylglycol methacrylate, n-propylglycol acrylate, n-butylglycol methacrylate, n-butylglycol acrylate, methyldiglycol methacrylate, methyldiglycol acrylate, ethyldiglycol methacrylate, ethyldiglycol acrylate, n-propyldiglycol methacrylate, n-propyldiglycol acrylate, n-butyldiglycol methacrylate, n-butyldiglycol acrylate, methoxypolyethylene glycol methacrylate, methoxypolyethylene glycol acrylate, ethoxypolyethylene glycol methacrylate, ethoxypolyethylene glycol acrylate, n-propoxypolyethylene glycol methacrylate, n-propoxypolyethylene glycol acrylate, n-butoxypolyethylene glycol methacrylate, n-butoxypolyethylene glycol acrylate and vinylformamide. Particularly preferred monomers d) are acrylamide, tert-butylacrylamide, dimethylaminoethyl methacrylate, methyl methacrylate, methyl acrylate, tert-butyl methacrylate, cyclohexyl methacrylate, n-butyldiglycol methacrylate, methoxypolyglycol methacrylate and vinylformamide. Very particular preference is given to methyl acrylate.

Further suitable monomers d) are, for example, 2-trimethylammonioethyl methacrylate chloride, 2-triethylammonioethyl acrylate chloride, 3-trimethylammoniopropyl acrylate chloride, 2-triethylammonioethyl methacrylate chloride, 3-triethylammoniopropyl acrylate chloride, 2-trimethylammonioethylmethacrylamide chloride, 2-trimethylammonioethylacrylamide chloride, 3-trimethylammoniopropylacrylamide chloride, 2-triethylammonioethylmethacrylamide chloride and 3-triethylammoniopropylacrylamide chloride. Particularly preferred monomers d) are 2-trimethylammonioethylmethacrylamide chloride and 3-trimethylammoniopropylacrylamide chloride.

The monomer solution or suspension comprises from 7.5 to 50% by weight, preferably 9 to 44% by weight, more preferably from 10 to 30% by weight and most preferably from 15 to 25% by weight of monomer d), based in each case on the unneutralized monomer a).

The copolymerization of the monomer a) with the monomers d) destroys the polymer chains which form. This possibly increases the free swell rate (FSR). The decline in the absorption under a pressure of 49.2 g/cm² (AUL0.7 psi) can be compensated for by correspondingly increasing the amounts of crosslinker b).

The water-soluble polymers e) used may be polyvinyl alcohol, polyvinylpyrrolidone, starch, starch derivatives, modified cellulose, such as methylcellulose or hydroxyethylcellulose, gelatin, polyglycols or polyacrylic acids, preferably starch, starch derivatives and modified cellulose.

Typically, an aqueous monomer solution is used. The water content of the monomer solution is preferably from 40 to 75% by weight, more preferably from 45 to 70% by weight and most preferably from 50 to 65% by weight. It is also possible to use monomer suspensions, i.e. monomer solutions with excess monomer a), for example sodium acrylate. With rising water content, the energy requirement in the subsequent drying rises, and, with falling water content, the heat of polymerization can only be removed inadequately.

For optimal action, the preferred polymerization inhibitors require dissolved oxygen. The monomer solution can therefore be freed of dissolved oxygen before the polymerization by inertization, i.e. flowing an inert gas through, preferably nitrogen or carbon dioxide. The oxygen content of the monomer solution is preferably lowered before the polymerization to less than 1 ppm by weight, more preferably to less than 0.5 ppm by weight, most preferably to less than 0.1 ppm by weight.

Suitable reactors are, for example, kneading reactors or belt reactors. In the kneader, the polymer gel formed in the polymerization of an aqueous monomer solution or suspension is comminuted continuously by, for example, contrarotatory stirrer shafts, as described in WO 2001/038402 A1. Polymerization on the belt is described, for example, in DE 38 25 366 A1 and U.S. Pat. No. 6,241,928. Polymerization in a belt reactor forms a polymer gel which has to be comminuted in a further process step, for example in an extruder or kneader.

To improve the drying properties, the comminuted polymer gel obtained by means of a kneader can additionally be extruded.

However, it is also possible to dropletize an aqueous monomer solution and to polymerize the droplets obtained in a heated carrier gas stream. It is possible here to combine the process steps of polymerization and drying, as described in WO 2008/040715 A2 and WO 2008/052971 A1.

The acid groups of the resulting polymer gels have typically been partially neutralized. Neutralization is preferably carried out at the monomer stage. This is typically accomplished by mixing in the neutralizing agent as an aqueous solution or preferably also as a solid. The degree of neutralization is preferably from 25 to 95 mol %, more preferably from 30 to 80 mol % and most preferably from 40 to 75 mol %, for which the customary neutralizing agents can be used, preferably alkali metal hydroxides, alkali metal oxides, alkali metal carbonates or alkali metal hydrogencarbonates and also mixtures thereof. Instead of alkali metal salts, it is also possible to use ammonium salts. Particularly preferred alkali metals are sodium and potassium, but very particular preference is given to sodium hydroxide, sodium carbonate or sodium hydrogencarbonate and also mixtures thereof.

However, it is also possible to carry out neutralization after the polymerization, at the stage of the polymer gel formed in the polymerization. It is also possible to neutralize up to 40 mol %, preferably from 10 to 30 mol % and more preferably from 15 to 25 mol % of the acid groups before the polymerization by adding a portion of the neutralizing agent actually to the monomer solution and setting the desired final degree of neutralization only after the polymerization, at the polymer gel stage. When the polymer gel is neutralized at least partly after the polymerization, the polymer gel is preferably comminuted mechanically, for example by means of an extruder, in which case the neutralizing agent can be sprayed, sprinkled or poured on and then carefully mixed in. To this end, the gel mass obtained can be repeatedly extruded for homogenization.

The polymer gel is then preferably dried with a belt drier until the residual moisture content is preferably 0.5 to 15% by weight, more preferably 1 to 10% by weight and most preferably 2 to 8% by weight, the residual moisture content being determined by EDANA recommended test method No. WSP 230.2-05 “Moisture Content”. In the case of too high a residual moisture content, the dried polymer gel has too low a glass transition temperature T_{g} and can be processed further only with difficulty. In the case of too low a residual moisture content, the dried polymer gel is too brittle and, in the subsequent comminution steps, undesirably large amounts of polymer particles with an excessively low particle size are obtained (“fines”). The solids content of the gel before the drying is preferably from 25 to 90% by weight, more preferably from 35 to 70% by weight and most preferably from 40 to 60% by weight. However, a fluidized bed drier or a paddle drier may optionally also be used for drying purposes.

Thereafter, the dried polymer gel is ground and classified, and the apparatus used for grinding may typically be single or multistage roll mills, preferably two or three-stage roll mills, pin mills, hammer mills or vibratory mills.

The mean particle size of the polymer particles removed as the product fraction is preferably at least 200 μm, more preferably from 250 to 600 μm and very particularly from 300 to 500 μm. The mean particle size of the product fraction may be determined by means of EDANA recommended test method No. WSP 220.2-05 “Particle Size Distribution”, where the proportions by mass of the screen fractions are plotted in cumulated form and the mean particle size is determined graphically. The mean particle size here is the value of the mesh size which gives rise to a cumulative 50% by weight.

The proportion of particles with a particle size of at least 150 μm is preferably at least 90% by weight, more preferably at least 95% by weight, most preferably at least 98% by weight.

Polymer particles with too small a particle size lower the permeability (SFC). The proportion of excessively small polymer particles (“fines”) should therefore be low.

Excessively small polymer particles are therefore typically removed and recycled into the process. This is preferably done before, during or immediately after the polymerization, i.e. before the drying of the polymer gel. The excessively small polymer particles can be moistened with water and/or aqueous surfactant before or during the recycling.

It is also possible to remove excessively small polymer particles in later process steps, for example after the surface postcrosslinking or another coating step. In this case, the excessively small polymer particles recycled are surface postcrosslinked or coated in another way, for example with fumed silica.

When a kneading reactor is used for polymerization, the excessively small polymer particles are preferably added during the last third of the polymerization.

When the excessively small polymer particles are added at a very early stage, for example actually to the monomer solution, this lowers the centrifuge retention capacity (CRC) of the resulting water-absorbing polymer particles. However, this can be compensated for, for example, by adjusting the amount of crosslinker b) used.

When the excessively small polymer particles are added at a very late stage, for example not until an apparatus connected downstream of the polymerization reactor, for example an extruder, the excessively small polymer particles can be incorporated into the resulting polymer gel only with difficulty. Insufficiently incorporated, excessively small polymer particles are, however, detached again from the dried polymer gel during the grinding, are therefore removed again in the course of classification and increase the amount of excessively small polymer particles to be recycled.

The proportion of particles having a particle size of at most 850 μm is preferably at least 90% by weight, more preferably at least 95% by weight, most preferably at least 98% by weight.

The proportion of particles having a particle size of at most 600 μm is preferably at least 90% by weight, more preferably at least 95% by weight, most preferably at least 98% by weight.

Polymer particles of excessively large particle size lower the free swell rate. The proportion of excessively large polymer particles should therefore likewise be small.

Excessively large polymer particles are therefore typically removed and recycled into the grinding of the dried polymer gel.

To further improve the properties, the polymer particles can be surface postcrosslinked. Suitable surface postcrosslinkers are compounds which comprise groups which can form covalent bonds with at least two carboxylate groups of the polymer particles. Suitable compounds are, for example, polyfunctional amines, polyfunctional amido amines, polyfunctional epoxides, as described in EP 0 083 022 A2, EP 0 543 303 A1 and EP 0 937 736 A2, di- or polyfunctional alcohols, as described in DE 33 14 019 A1, DE 35 23 617 A1 and EP 0 450 922 A2, or β-hydroxyalkylamides, as described in DE 102 04 938 A1 and U.S. Pat. No. 6,239,230.

Additionally described as suitable surface postcrosslinkers are cyclic carbonates in DE 40 20 780 C1, 2-oxazolidinone and derivatives thereof, such as 2-hydroxyethyl-2-oxazolidinone, in DE 198 07 502 A1, bis- and poly-2-oxazolidinones in DE 198 07 992 C1, 2-oxotetrahydro-1,3-oxazine and derivatives thereof in DE 198 54 573 A1, N-acyl-2-oxazolidinones in DE 198 54 574 A1, cyclic ureas in DE 102 04 937 A1, bicyclic amide acetals in DE 103 34 584 A1, oxetanes and cyclic ureas in EP 1 199 327 A2 and morpholine-2,3-dione and derivatives thereof in WO 2003/031482 A1.

Preferred surface postcrosslinkers are ethylene carbonate, ethylene glycol diglycidyl ether, reaction products of polyamides with epichlorohydrin and mixtures of propylene glycol and 1,4-butanediol.

Very particularly preferred surface postcrosslinkers are 2-hydroxyethyl-2-oxazolidinone, 2-oxazolidinone and 1,3-propanediol.

In addition, it is also possible to use surface postcrosslinkers which comprise additional polymerizable ethylenically unsaturated groups, as described in DE 37 13 601 A1.

The amount of surface postcrosslinker is preferably 0.001 to 2% by weight, more preferably 0.02 to 1% by weight and most preferably 0.05 to 0.2% by weight, based in each case on the polymer particles.

In a preferred embodiment of the present invention, polyvalent cations are applied to the particle surface in addition to the surface postcrosslinkers before, during or after the surface postcrosslinking.

The polyvalent cations usable in the process according to the invention are, for example, divalent cations such as the cations of zinc, magnesium, calcium, iron and strontium, trivalent cations such as the cations of aluminum, iron, chromium, rare earths and manganese, tetravalent cations such as the cations of titanium and zirconium. Possible counterions are hydroxide, chloride, bromide, sulfate, hydrogensulfate, carbonate, hydrogencarbonate, nitrate, phosphate, hydrogenphosphate, dihydrogenphosphate and carboxylate, such as acetate, citrate and lactate. Salts with different counterions are also possible, for example basic aluminum salts such as aluminum monoacetate or aluminum monolactate. Aluminum sulfate, aluminum monoacetate and aluminum lactate are preferred. Apart from metal salts, it is also possible to use polyamines as polyvalent cations.

The amount of polyvalent cation used is, for example, 0.001 to 1.5% by weight, preferably 0.005 to 1% by weight and more preferably 0.02 to 0.8% by weight, based in each case on the polymer particles.

The surface postcrosslinking is typically performed in such a way that a solution of the surface postcrosslinker is sprayed onto the dried polymer particles. After the spray application, the polymer particles coated with surface postcrosslinker are dried thermally, and the surface postcrosslinking reaction can take place either before or during the drying.

The spray application of a solution of the surface postcrosslinker is preferably performed in mixers with moving mixing tools, such as screw mixers, disk mixers and paddle mixers. Particular preference is given to horizontal mixers such as paddle mixers, very particular preference to vertical mixers. The distinction between horizontal mixers and vertical mixers is made by the position of the mixing shaft, i.e. horizontal mixers have a horizontally mounted mixing shaft and vertical mixers a vertically mounted mixing shaft. Suitable mixers are, for example, horizontal Pflugschar® plowshare mixers (Gebr. Lödige Maschinenbau GmbH; Paderborn; Germany), Vrieco-Nauta continuous mixers (Hosokawa Micron BV; Doetinchem; the Netherlands), Processall Mixmill mixers (Processall Incorporated; Cincinnati; USA) and Schugi Flexomix® (Hosokawa Micron BV; Doetinchem; the Netherlands). However, it is also possible to spray on the surface postcrosslinker solution in a fluidized bed.

The surface postcrosslinkers are typically used in the form of an aqueous solution. The penetration depth of the surface postcrosslinker into the polymer particles can be adjusted via the content of nonaqueous solvent and total amount of solvent.

When exclusively water is used as the solvent, a surfactant is advantageously added. This improves the wetting behavior and reduces the tendency to form lumps. However, preference is given to using solvent mixtures, for example isopropanol/water, 1,3-propanediol/water and propylene glycol/water, where the mixing ratio in terms of mass is preferably from 20:80 to 40:60.

The thermal drying is preferably carried out in contact driers, more preferably paddle driers, most preferably disk driers. Suitable driers are, for example, Hosokawa Bepex® Horizontal Paddle Dryer (Hosokawa Micron GmbH; Leingarten; Germany), Hosokawa Bepex® Disc Dryer (Hosokawa Micron GmbH; Leingarten; Germany), Holo-Flite® driers (Metso Minerals Industries Inc.; Danville; USA) and Nara Paddle Dryer (NARA Machinery Europe; Frechen; Germany). Moreover, fluidized bed driers may also be used.

The drying can be effected in the mixer itself, by heating the jacket or blowing in warm air. Equally suitable is a downstream dryer, for example a shelf drier, a rotary tube oven or a heatable screw. It is particularly advantageous to effect mixing and drying in a fluidized bed drier.

Preferred drying temperatures are in the range of 100 to 250° C., preferably 120 to 220° C., more preferably 130 to 210° C. and most preferably 150 to 200° C. The preferred residence time at this temperature in the reaction mixer or drier is preferably at least 10 minutes, more preferably at least 20 minutes, most preferably at least 30 minutes, and typically at most 60 minutes.

In a preferred embodiment of the present invention, the water-absorbing polymer particles are cooled after the thermal drying. The cooling is preferably performed in contact coolers, more preferably paddle coolers and most preferably disk coolers. Suitable coolers are, for example, Hosokawa Bepex® Horizontal Paddle Cooler (Hosokawa Micron GmbH; Leingarten; Germany), Hosokawa Bepex® Disc Cooler (Hosokawa Micron GmbH; Leingarten; Germany), Holo-Flite® coolers (Metso Minerals Industries Inc.; Danville; USA) and Nara Paddle Cooler (NARA Machinery Europe; Frechen; Germany). Moreover, fluidized bed coolers may also be used.

In the cooler, the water-absorbing polymer particles are cooled to 20 to 150° C., preferably 40 to 120° C., more preferably 60 to 100° C. and most preferably 70 to 90° C.

Subsequently, the surface postcrosslinked polymer particles can be classified again, excessively small and/or excessively large polymer particles being removed and recycled into the process.

To further improve the properties, the surface postcrosslinked polymer particles can be coated or remoisturized.

The remoisturizing is preferably performed at 30 to 80° C., more preferably at 35 to 70° C., most preferably at 40 to 60° C. At excessively low temperatures, the water-absorbing polymer particles tend to form lumps, and, at higher temperatures, water already evaporates to a noticeable degree. The amount of water used for remoisturizing is preferably from 1 to 10% by weight, more preferably from 2 to 8% by weight and most preferably from 3 to 5% by weight. The remoisturizing increases the mechanical stability of the polymer particles and reduces their tendency to static charging. The remoisturizing is advantageously performed in the cooler after the thermal drying.

Suitable coatings for improving the swell rate and the permeability (SFC) are, for example, inorganic inert substances, such as water-insoluble metal salts, organic polymers, cationic polymers and di- or polyvalent metal cations. Suitable coatings for dust binding are, for example, polyols. Suitable coatings for counteracting the undesired caking tendency of the polymer particles are, for example, fumed silica, such as Aerosil® 200, and surfactants, such as Span® 20.

The present invention further provides the water-absorbing polymer particles obtainable by the process according to the invention.

The inventive water-absorbing polymer particles have a centrifuge retention capacity (CRC) of typically at least 15 g/g, preferably at least 20 g/g, more preferably at least 25 g/g, especially preferably at least 30 g/g and most preferably at least 35 g/g. The centrifuge retention capacity (CRC) of the water-absorbing polymer particles is typically less than 60 g/g.

The inventive water-absorbing polymer particles have an absorption under a pressure of 49.2 g/cm² (AUL0.7 psi) of typically at least 10 g/g, preferably at least 15 g/g, more preferably at least 20 g/g, especially preferably at least 22 g/g and most preferably at least 23 g/g. The absorption under a pressure of 49.2 g/cm² (AUL0.7 psi) of the water-absorbing polymer particles is typically less than 30 g/g.

The inventive water-absorbing polymer particles have a saline flow conductivity (SFC) of typically at least 50×10⁻⁷ cm³s/g, preferably at least 80×10⁻⁷ cm³s/g, more preferably at least 100×10⁻⁷ cm³s/g, especially preferably at least 120×10⁻⁷ cm³s/g and most preferably at least 130×10⁻⁷ cm³s/g. The saline flow conductivity (SFC) of the water-absorbing polymer particles is typically less than 250×10⁻⁷ cm³s/g.

The present invention further provides hygiene articles comprising inventive water-absorbing polymer particles, especially hygiene articles for feminine hygiene, hygiene articles for light and heavy incontinence, or small animal litter.

The production of the hygiene articles is described in the monograph “Modern Superabsorbent Polymer Technology”, F. L. Buchholz and A. T. Graham, Wiley-VCH, 1998, pages 252 to 258.

The hygiene articles typically comprise a water-impervious backside, a water-pervious topside and an intermediate absorbent core composed of the inventive water-absorbing polymer particles and fibers, preferably cellulose. The proportion of the inventive water-absorbing polymer particles in the absorbent core is preferably 20 to 100% by weight and more preferably 50 to 100% by weight.

### Methods

The standard test methods described hereinafter and designated “WSP” are described in: “Standard Test Methods for the Nonwovens Industry”, 2005 edition, published jointly by the Worldwide Strategic Partners EDANA (Avenue Eugene Plasky, 157, 1030 Brussels, Belgium, www.edana.org) and INDA (1100 Crescent Green, Suite 115, Cary, N.C. 27518, U.S.A., www.inda.org). This publication is available both from EDANA and from INDA.

The measurements should, unless stated otherwise, be carried out at an ambient temperature of 23±2° C. and a relative air humidity of 50±10%. The water-absorbing polymer particles are mixed thoroughly before the measurement.

### Free Swell Rate

To determine the free swell rate (FSR), 1.00 g (=W1) of the water-absorbing polymer particles is weighed into a 25 ml beaker and distributed homogeneously over its base. Then 20 ml of a 0.9% by weight sodium chloride solution are metered into a second beaker by means of a dispenser and the contents of this beaker are added rapidly to the first and a stopwatch is started. As soon as the last drop of salt solution has been absorbed, which is recognized by the disappearance of the reflection on the liquid surface, the stopwatch is stopped. The exact amount of liquid which has been poured out of the second beaker and absorbed by the polymer in the first beaker is determined accurately by reweighing the second beaker (=W2). The time interval required for the absorption, which has been measured with the stopwatch, is designated as t. The disappearance of the last liquid droplet on the surface is determined as the time t.

The free swell rate (FSR) is calculated therefrom as follows:

FSR [g/(g*s)]=W2/(W1×t)

If the moisture content of the water-absorbing polymer particles, however, is more than 3% by weight, the weight W1 should be corrected to take account of this moisture content.

### Centrifuge Retention Capacity

The centrifuge retention capacity (CRC) of the water-absorbing polymer particles is determined by EDANA recommended test method No. WSP 241.2-05 “Centrifuge Retention Capacity”.

Absorption under a pressure of 49.2 g/cm²

The absorption under a pressure of 49.2 g/cm² (AUL0.7 psi) of the water-absorbing polymer particles is determined analogously to EDANA recommended test method No. WSP 242.2-05 “Absorption under Pressure”, except that a pressure of 49.2 g/cm² (AUL0.7 psi) is established instead of a pressure of 21.0 g/cm² (AUL0.3 psi).

### EXAMPLES

### Production of the Base Polymers

### Example 1 (Comparative Example)

A VT 5R-MK Pflugschar® plowshare kneader (Gebr. Lödige Maschinenbau GmbH, Paderborn, Germany) was initially charged with 250.9 g of water, 268.8 g of acrylic acid, 2094.3 g of a 37.3% by weight aqueous sodium acrylate solution and 3.1 g of triethoxylated glyceryl triacrylate (0.71 equivalent by weight), and inertized by sparging with nitrogen for 20 minutes. Subsequently, the polymerization was initiated at approx. 25° C. by adding 5.1 g of a 15% by weight aqueous sodium persulfate solution, 2.2 g of a 0.5% by weight aqueous ascorbic acid solution and 0.6 g of a 3% by weight aqueous hydrogen peroxide solution. The temperature of the heating jacket tracked the reaction temperature, in order to conduct the reaction to completion under very substantially adiabatic conditions. The resulting gel was cooled, discharged and dried in a forced-air drying cabinet at 175° C. for 90 minutes. The product was then ground and screened off to 150 to 710 μm.

The resulting water-absorbing polymer particles were analyzed. The results are summarized in Table 1.

### Example 2

A VT 5R-MK Pflugschar® plowshare kneader (Gebr. Lödige Maschinenbau GmbH, Paderborn, Germany) was initially charged with 250.1 g of water, 254.9 g of acrylic acid, 1887.4 g of a 37.3% by weight aqueous sodium acrylate solution, 182.1 g of a 50% by weight aqueous solution of the sodium salt of 2-acrylamido-2-methylpropanesulfonic acid (AMPS) and 3.0 g of triethoxylated glyceryl triacrylate (0.76 equivalent by weight), and inertized by sparging with nitrogen for 20 minutes. Subsequently, the polymerization was initiated at approx. 25° C. by adding 4.9 g of a 15% by weight aqueous sodium persulfate solution, 2.1 g of a 0.5% by weight aqueous ascorbic acid solution and 0.6 g of a 3% by weight aqueous hydrogen peroxide solution. The temperature of the heating jacket tracked the reaction temperature, in order to conduct the reaction to completion under very substantially adiabatic conditions. The resulting gel was cooled, discharged and dried in a forced-air drying cabinet at 175° C. for 90 minutes. The product was then ground and screened off to 150 to 710 μm.

The resulting water-absorbing polymer particles were analyzed. The results are summarized in Table 1.

### Example 3

A VT 5R-MK Pflugschar® plowshare kneader (Gebr. Lödige Maschinenbau GmbH, Paderborn, Germany) was initially charged with 326.1 g of water, 242.5 g of acrylic acid, 1700.1 g of a 37.3% by weight aqueous sodium acrylate solution, 346.4 g of a 50% by weight aqueous solution of the sodium salt of 2-acrylamido-2-methylpropanesulfonic acid (AMPS) and 2.8 g of triethoxylated glyceryl triacrylate (0.77 equivalent by weight), and inertized by sparging with nitrogen for 20 minutes. Subsequently, the polymerization was initiated at approx. 25° C. by adding 4.6 g of a 15% by weight aqueous sodium persulfate solution, 2.0 g of a 0.5% by weight aqueous ascorbic acid solution and 0.5 g of a 3% by weight aqueous hydrogen peroxide solution. The temperature of the heating jacket tracked the reaction temperature, in order to conduct the reaction to completion under very substantially adiabatic conditions. The resulting gel was cooled, discharged and dried in a forced-air drying cabinet at 175° C. for 90 minutes. The product was then ground and screened off to 150 to 710 μm.

The resulting water-absorbing polymer particles were analyzed. The results are summarized in Table 1.

### Example 4

A VT 5R-MK Pflugschar® plowshare kneader (Gebr. Lödige Maschinenbau GmbH, Paderborn, Germany) was initially charged with 318.3 g of water, 226.3 g of acrylic acid, 1987.7 g of a 37.3% by weight aqueous sodium acrylate solution, 82.3 g of 2-acrylamido-2-methylpropanesulfonic acid (AMPS) and 3.0 g of triethoxylated glyceryl triacrylate (0.76 equivalent by weight), and inertized by sparging with nitrogen for 20 minutes. Subsequently, the polymerization was initiated at approx. 25° C. by adding 4.9 g of a 15% by weight aqueous sodium persulfate solution, 2.1 g of a 0.5% by weight aqueous ascorbic acid solution and 0.6 g of a 3% by weight aqueous hydrogen peroxide solution. The temperature of the heating jacket tracked the reaction temperature, in order to conduct the reaction to completion under very substantially adiabatic conditions. The resulting gel was cooled, discharged and dried in a forced-air drying cabinet at 175° C. for 90 minutes. The product was then ground and screened off to 150 to 710 μm.

The resulting water-absorbing polymer particles were analyzed. The results are summarized in Table 1.

### Example 5

A VT 5R-MK Pflugschar® plowshare kneader (Gebr. Lödige Maschinenbau GmbH, Paderborn, Germany) was initially charged with 373.3 g of water, 183.6 g of acrylic acid, 1900.8 g of a 37.3% by weight aqueous sodium acrylate solution, 183.6 g of a 50% by weight aqueous solution of the sodium salt of 2-acrylamido-2-methylpropanesulfonic acid (AMPS) and 2.8 g of triethoxylated glyceryl triacrylate (0.77 equivalent by weight), and inertized by sparging with nitrogen for 20 minutes. Subsequently, the polymerization was initiated at approx. 25° C. by adding 4.6 g of a 15% by weight aqueous sodium persulfate solution, 2.0 g of a 0.5% by weight aqueous ascorbic acid solution and 0.5 g of a 3% by weight aqueous hydrogen peroxide solution. The temperature of the heating jacket tracked the reaction temperature, in order to conduct the reaction to completion under very substantially adiabatic conditions. The resulting gel was cooled, discharged and dried in a forced-air drying cabinet at 175° C. for 90 minutes. The product was then ground and screened off to 150 to 710 μm.

The resulting water-absorbing polymer particles were analyzed. The results are summarized in Table 1.

### Example 6 (Comparative Example)

A 21 stainless steel beaker was initially charged with 326.7 g of 50% by weight sodium hydroxide solution and 849.0 g of frozen deionized water. 392.0 g of acrylic acid were added while stirring, in the course of which the rate of addition was adjusted such that the temperature did not exceed 35° C. The mixture was then cooled to 20° C. with stirring and the aid of a cooling bath. Subsequently, 0.80 g of triethoxylated glyceryl triacrylate (0.41 equivalent by weight), 0.041 g of 2-hydroxy-2-methyl-1-phenylpropan-1-one (DAROCUR® 1173, Ciba Specialty Chemicals Inc., Basle, Switzerland) and 0.014 g of 2,2-dimethoxy-1,2-diphenylethan-1-one (IRGACURE® 651, Ciba Specialty Chemicals Inc., Basle, Switzerland) were added. Cooling was continued, and on attainment of 15° C. the mixture was freed of oxygen by passing nitrogen through by means of a glass frit. On attainment of 0° C., 0.51 g of sodium persulfate (dissolved in 5 ml of water) and 0.06 g of hydrogen peroxide (dissolved in 6 ml of water) were added, and the monomer solution was transferred into a glass dish. The glass dish had such dimensions as to establish a layer thickness of the monomer solution of 5 cm. Subsequently, 0.047 g of mixture of the sodium salt of 2-hydroxy-2-sulfinatoacetic acid, the disodium salt of 2-hydroxy-2-sulfonatoacetic acid and sodium bisulfite (Bruggolit® FF7, L. Brüggemann K G, Heilbronn, Germany), dissolved in 5 ml of water, was added and the monomer solution was stirred briefly with the aid of a glass rod. The glass dish containing the monomer solution was placed under a UV lamp (UV intensity=25 mW/cm²), and polymerization set in. After 16 minutes, the resulting gel was extruded three times with the aid of a commercial meat grinder with a 6 mm die plate, and dried in a laboratory drying cabinet at 160° C. for one hour. The product was then ground and screened off to 150 to 600 μM.

The resulting water-absorbing polymer particles were analyzed. The results are summarized in Table 1.

### Example 7 (Comparative Example)

Example 6 was repeated, except that, after the neutralization step, 78.4 g of a 50% by weight aqueous solution of the sodium salt of 2-acrylamido-2-methylpropanesulfonic acid (AMPS) were additionally added to the monomer solution.

The resulting water-absorbing polymer particles were analyzed. The results are summarized in Table 1.

TABLE 1
Base polymers

| | | Amount | CRC | FSR |
|---|---|---|---|---|
| Example | Comonomer | [% by wt.] | [g/g] | [g/(g * s)] |
| 1*) | | | 34.9 | 0.34 |
| 2 | Na-AMPS | 16 | 34.7 | 0.39 |
| 3 | ″ | 24 | 34.4 | 0.42 |
| 4 | AMPS | 10 | 35.8 | 0.43 |
| 5 | ″ | 22 | 36.7 | 0.44 |
| 6*) | | | 40.8 | |
| 7*) | Na-AMPS | 10 | 52.6 | |

*)comparative examples
Na-AMPS: sodium salt of 2-acrylamido-2-methylpropanesulfonic acid
AMPS: 2-acrylamido-2-methylpropanesulfonic acid

### Surface Postcrosslinking

### Examples 8 to 12

In an M5 Pflugschar® plowshare mixer with heating jacket (Gebr. Lödige Maschinenbau GmbH, Paderborn, Germany), in each case 1.2 kg of base polymer from examples 1 to 5 were coated at 185° C. and a shaft speed of 250 revolutions per minute by means of a two-substance spray nozzle (0.5 bar of nitrogen) with the following solution (based in each case on the base polymer):

0.14% by weight of N-(2-hydroxyethyl)-2-oxazolidinone

0.7% by weight of 1,2-propanediol

2.42% by weight of water

1.04% by weight of isopropanol

0.25% by weight of a 2% by weight aqueous solution of sorbitan monooleate

After the spray application, the reaction mixture was held at 185° C. and a shaft speed of 200 revolutions per minute for 40 minutes. The resulting products were allowed to cool again to 23° C. and, to remove agglomerates, screened off at 710 μm.

The resulting water-absorbing polymer particles were analyzed. The results are summarized in Table 2.

### Examples 13 and 14

For surface postcrosslinking, the base polymers of examples 6 and 7 were coated in an M5 Pflugschar® plowshare mixer with heating jacket (Gebr. Lödige Maschinenbau GmbH, Paderborn, Germany) at 23° C. and a shaft speed of 250 revolutions per minute by means of a two-substance spray nozzle with the following solution (based in each case on the base polymer):

1.00% by weight of 1,3-propanediol

0.04% by weight of N-(2-hydroxyethyl)-2-oxazolidinone

2.0% by weight of water

0.6% by weight of a 22% by weight aqueous aluminum lactate solution

After the spray application, the product temperature was increased to 170° C. and the reaction mixture was held at this temperature and a shaft speed of 60 revolutions per minute for 45 minutes. The products obtained were allowed to cool again to 23° C. and screened off to 150 to 600 μm.

The resulting water-absorbing polymer particles were analyzed. The results are summarized in Table 2.

TABLE 2
surface postcrosslinked base polymers

| | | | Amount | | | FSR |
|---|---|---|---|---|---|---|
| | Base | | [% by | CRC | AUL0.7 psi | [g/ |
| Example | polymer | Comonomer | wt.] | [g/g] | [g/g] | (g*s)] |
| 8*) | 1 | | | 27.0 | 26.0 | 0.24 |
| 9 | 2 | Na-AMPS | 16 | 25.6 | 24.2 | 0.28 |
| 10 | 3 | ″ | 24 | 26.3 | 24.6 | 0.29 |
| 11 | 4 | AMPS | 10 | 27.2 | 25.1 | 0.28 |
| 12 | 5 | ″ | 22 | 28.4 | 25.4 | 0.31 |
| 13*) | 6 | | | 36.4 | 20.3 | |
| 14*) | 7 | Na-AMPS | 10 | 41.2 | 14.3 | |

*)comparative examples
Na-AMPS: sodium salt of 2-acrylamido-2-methylpropanesulfonic acid
AMPS: 2-acrylamido-2-methylpropanesulfonic acid

1. A process for producing water-absorbing polymer particles by polymerizing a monomer solution or suspension comprising
a) an ethylenically unsaturated monomer which bears an acid group and may be at least partly neutralized,
b) at least one crosslinker,
c) at least one initiator,
d) at least one ethylenically unsaturated monomer copolymerizable with the monomer mentioned under a), and
e) optionally one or more water-soluble polymer,
wherein the monomer solution or suspension comprises at least 0.5 equivalent by weight of the crosslinker b), where one equivalent by weight corresponds to a percentage by weight of the crosslinker b), based on the unneutralized monomer a), multiplied by (n−1) and n is a number of ethylenic double bonds in the crosslinker b), and from 7.5 to 50% by weight of the monomer d), based on the unneutralized monomer a).

2. The process according to claim 1, wherein the monomer a) is acrylic acid neutralized to an extent of 25 to 95 mol %.

3. The process according to claim 1, wherein the monomer solution or suspension comprises from 10 to 30% by weight of the monomer d), based on the unneutralized monomer a).

4. The process according to claim 1, wherein the monomer d) is 2-acrylamido-2-methylpropanesulfonic acid, methyl acrylate, and/or methacrylic acid.

5. The process according to claim 1, wherein the water-absorbing polymer particles are surface postcrosslinked by formation of covalent bonds.

6. The process according to claim 5, wherein polyvalent cations are applied to particle surfaces before, during, or after the surface postcrosslinking.

7. Water-absorbing polymer particles prepared by polymerizing a monomer solution or suspension comprising
a) an ethylenically unsaturated monomer which bears an acid group and may be at least partly neutralized,
b) at least one crosslinker,
c) at least one initiator,
d) at least one ethylenically unsaturated monomer copolymerizable with the monomer mentioned under a), and
e) optionally one or more water-soluble polymer, the monomer solution or suspension comprising at least 0.5 equivalent by weight of the crosslinker b), where one equivalent by weight corresponds to a percentage by weight of the crosslinker b), based on the unneutralized monomer a), multiplied by (n−1) and n is a number of ethylenic double bonds in the crosslinker b), and from 7.5 to 50% by weight of the monomer d), based on the unneutralized monomer a).

8. Water-absorbing polymer particles according to claim 7, wherein the monomer a) is acrylic acid neutralized to an extent of 25 to 95 mol %.

9. Water-absorbing polymer particles according to claim 7, wherein the monomer solution or suspension comprises from 10 to 30% by weight of the monomer d), based on the unneutralized monomer a).

10. Water-absorbing polymer particles according to claim 7, wherein the monomer d) is 2-acrylamido-2-methylpropanesulfonic acid, methyl acrylate, and/or methacrylic acid.

11. Water-absorbing polymer particles according to claim 7, which are surface postcrosslinked by formation of covalent bonds.

12. Water-absorbing polymer particles according to claim 11, wherein polyvalent cations are applied to particle surfaces before, during, or after the surface postcrosslinking.

13. Water-absorbing polymer particles according to claim 7, wherein the water-absorbing polymer particles have a centrifuge retention capacity of at least 15 g/g.

14. A hygiene article comprising water-absorbing polymer particles according to claim 7.
